(19) United States
(12) Patent Application Publication
(10) Pub. No.: US 2020/0334884 A1
(43) Pub. Date: Oct. 22, 2020

(54) VIRTUALIZED THREE DIMENSIONAL ANIMATION POST-PRODUCTION TECHNIQUE FOR MOTION PICTURE AND VIRTUAL ENVIRONMENTS

(71) Applicant: Jay Wright, Eureka, CA (US)

(72) Inventor: Jay Wright, Eureka, CA (US)

(21) Appl. No.: 15/932,441

(22) Filed: Feb. 5, 2018

(51) Int. Cl. G06T 13/20; G05B 19/4099

(52) U.S. Cl. CPC G06T 13/20; G05B 2219/33099; G05B 19/4099

(57) ABSTRACT

The present invention comprises a series of steps used to create 3D animation cells for assembly via traditional motion picture techniques such as photography, scanning using a 3D scanner, direct 3D transcription (e.g. touching the object) for virtualization.

1. Handmade drawings, computer assisted animation (CAD), sculptures (or some combination of these elements) for photographing, scanning, direct transcription.

2. Scanning and assembly in a virtual environment.

3. Animation comprising all or some of the elements e.g. ‘compositing’: 3D printing, 3D relief or CNC of each frame of the elements, and/or partials, assembled and animated in the virtualized environment.

4. Motion capture, scanning, direct transcription of the composited outputted parts to be used as animation frames.

5. Output of the animated individual elements to motion picture and/or virtual environment.

### CROSS-REFERENCES RELATED TO APPLICATION

not applicable

### STATEMENT REGARDING FEDERALLY SPONSORED RESEARCH OR DEVELOPEMENT

not applicable

### MICROFICHE APPENDIX

not applicable

### BACKGROUND OF THE INVENTION

### 1. Field of the Invention

The field of the invention relates to animation for motion pictures and virtual environments; specifically the creation of individual and sets of animation cells or frames three dimensional (3D) replication tools such as 3D printers, CNC (computer numerical control) machines and 3D relief machines.

### 2. Description of the Related Art

There are many animation techniques for motion pictures and virtual environments. In general there have been three types: (1.) direct manipulation of the motion picture stock, (2.) re-photographed drawings or (3.) computer signal output to digital two dimensional (2D) motion picture photography, 3D virtual environment or printed back to stock. In recent years this has also included animation (computer and traditional 2D) output to virtual environments (virtualization) for many purposes: scientific, business, gaming or other. These motion picture and virtual manipulation techniques have been 2D (two dimensional physical form) or virtual (only existing in digital form) i.e. no physical existence. The present invention seeks to provide a 3D process of animation for physical and virtual (digital) forms.

### BRIEF DESCRIPTION OF VIEW OF THE DRAWING

View is a schematic flowchart.

### REFERENCE NUMERAL IN DRAWING

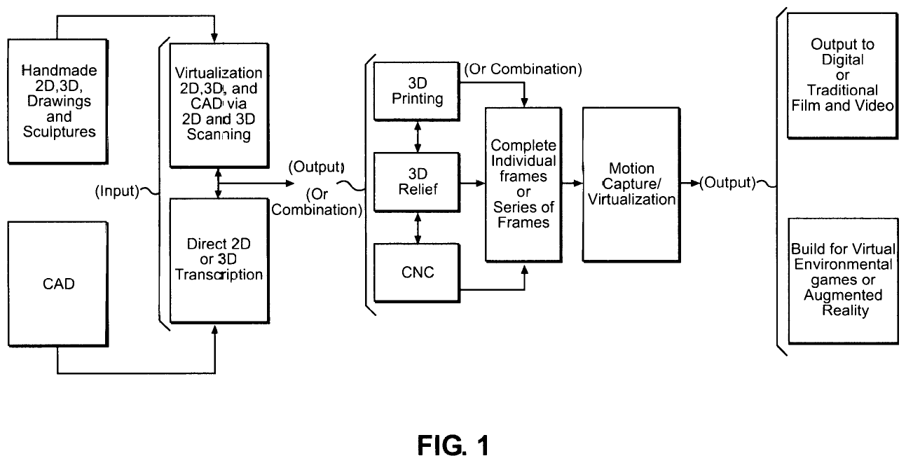

FIG. 1.

Input:

Handmade drawings sculptures and/or:

Computer assisted animation (CAD) and/or:

Photography of one or more of the required elements and/or:

2D scanning of one or more of the required elements and/or:

3D scanning of one or more of the required elements and/or:

Compositing and/or:

Animation.

Output or combination as:

3D printing output of required elements as individual animated frames or partials and/or:

CNC output of required elements as individual animated frames or partials and/or:

3D relief output of required elements as individual animated frames or partials and/or:

More input as necessary.

Capture of the three dimensional frames or partials via 3D scan, 3D transcription or motion picture photography.

Output to motion picture of 3D frame captures and/or:

3D animation output to computer build for virtual environment.

1. Animation process comprising real objects and environments virtualized for two dimensional time arts.

2. Animation process comprising virtual objects and environments transcribed to real for two dimensional time arts.

3. Animation process comprising virtualized real objects and environments for virtual experience in real time.

4. Use of computer aided printing, cutting, relief and transcription to facilitate experience of the objects and environments in real time.
